(19) United States
(12) Patent Application Publication
(10) Pub. No.: US 2024/0345897 A1
(43) Pub. Date: Oct. 17, 2024

(54) SYSTEM AND METHOD FOR CLOUD ARCHITECTURE DESIGN AND DIAGRAM GENERATION USING ARTIFICIAL INTELLIGENCE

(71) Applicant: Accenture Global Solutions Limited, Dublin (IE)

(72) Inventors: Manish Ahuja, Gadarpur (IN); Swapnajeet Gon Choudhury, Bangalore (IN); Kapil Singi, Bangalore (IN); Kuntal Dey, Rampurhat (IN); Vikrant Kaulgud, Pune (IN); Adam Patten Burden, Tampa, FL (US)

(21) Appl. No.: 18/301,703

(22) Filed: Apr. 17, 2023

(51) Int. Cl. G06F 9/50; G06F 11/34

(52) U.S. Cl. CPC G06F 9/5077; G06F 11/3495

(57) ABSTRACT

Intelligent AI-based systems and methods of generating architecture diagrams for cloud computing-based infrastructures. The system can ingest and process requirement data and identify intents associated with the software. Based on the classifications of the requirement data, the system can automatically extract dependencies between software layers and microservices in order to identify the most appropriate components for the application. In some embodiments, validation can be performed in which a digital twin model is implemented. Implementation of such as system can eliminate manual errors and variability based on human skill sets, as well as enable risk-free testing of the architecture based on the application goals.

### TECHNICAL FIELD

The present disclosure generally relates to intelligent provisioning of infrastructures for cloud-based architectures, and more particularly to efficient extraction of dependencies and the encoding of requirements into an architecture using artificial intelligence (AI).

### BACKGROUND

Cloud computing has seen increasing use for a variety of reasons, including cost savings, ease of maintenance, scalability, and versatility. Cloud computing provides many different types of cloud services, such as information as a service (IaaS) applications (e.g., information technology applications, networking applications, data storage applications, etc.), platform as a service (PaaS) applications (e.g., hardware applications, operating system applications, etc.), and software as a service (SaaS) applications (e.g., email applications, word processing applications, image applications, etc.).

Cloud applications have several attributes that make them different than typical software applications. For example, cloud applications execute on virtualized hardware and a software stack that can be moved and replicated between physical machines as needed, share common physical resources with other cloud applications, are built to be highly scalable in real-time, and are predominately accessed using standard network protocols. Furthermore, cloud applications use hypertext markup language (HTML) and other web technologies for providing front-end and management user interfaces, provide application programming interfaces (APIs) for integration and management, consume third-party APIs for providing common services and functionality, and tend to use no structured query language (SQL) data stores.

Thus, it can be appreciated that a cloud-based infrastructure can facilitate future scalability requirements, ease of development, availability, and resiliency, among other benefits. The application architecture is expected to cater to a user's application requirements, provide adherence to well architected framework, reduce computation costs, and manage complex dependencies between architecture components. However, designing an architecture for a cloud-native application without comprehensive knowledge of the unique or specialized requirements of the platform usually results in substandard products that are deficient in reliability, security, and performance. In most cases, the ultimate quality of an architecture is dependent on the knowledge and skills of a highly experienced system architect. Indeed, the way an architecture is provisioned can be heavily impact decisions in how the system will be able to handle requirements and adapt to new dependencies. These and other aspects make dependable and effective production of architectures for cloud applications very challenging, with the process continuing to consume vast amounts of time, resources, and capital.

There is a need in the art for a system and method that addresses the shortcomings discussed above.

### SUMMARY

The proposed systems and methods describe a dynamic and automated process for generating architecture diagrams for application development and cloud deployment. The system and method solve the problems discussed above by providing an artificial intelligence-driven system and method for identifying specific application components that would be best suited to the user requirements for a given project. The system can use natural language processing techniques to ingest and process requirement data and identify intents associated with the software. Based on the classifications of the requirement data, the system can automatically extract dependencies between software layers and microservices in order to identify the most appropriate components for the application. For example, the proposed system can identify the various services (micro-service)/components that are necessary to implement the requirements, what layers would be required to implement the system, as well as how the architectural layers and components within the layers are interconnected. The system can then propose which of the identified components would be best-suited or most appropriate to the various service identifies and ultimately generate a system architecture diagram. In some embodiments, validation can be performed in which a digital twin model is implemented. Implementation of such as system can eliminate manual errors and variability based on human skill sets, as well as enable risk-free testing of the architecture based on the application goals. In some embodiments, the architecture can be used downstream to facilitate and even help expedite the provisioning process. Furthermore, the proposed embodiments significantly reduce the time needed to generate an architecture, optimizes architectural quality, and standardizes the architecture generation process.

The architecture diagram can then be used to manage and plan the provisioning of the software application in multi-cloud environments. In one embodiment, the system can automatically provision the cloud computing-based infrastructure based on the architecture diagram. These features (among others described) are specific improvements in way that the underlying computer system operates. In addition, the proposed systems and methods solve technical challenges with cloud infrastructure development and validation. The improvements facilitate a more efficient, accurate, consistent, and precise building of resources that operate properly immediately upon entering the production environment. The improved functioning of the underlying computer hardware itself achieves further technical benefits. For example, the system avoids the risks of relying on arbitrary human knowledge and skill sets to design the most optimized arrangement of layers and components, reduces manual intervention, accelerates the timeline for successful completion of a system's cloud deployment, and reduces the possibility for human error, therefore increasing infrastructure instantiation efficiency and reduces wait times for correct resource setup and execution.

In one aspect, the disclosure provides a computer-implemented method of generating an application architecture for a cloud computing-based infrastructure. The method includes receiving, at a requirement orchestrator module, a first requirements dataset for a software application including a first requirement, and a second step of identifying, at the requirement orchestrator module using a first machine learning (ML) model trained to determine an intent(s) for a given requirement, a first intent based on the first requirement. The method also includes passing, from the requirement orchestrator module, the first requirement and the first intent to an architecture generator module. The method includes assigning, at the architecture generator module, the first requirement to a first application layer based on the first intent. The method includes selecting, at the architecture generator module, a first microservice from a set of microservices based on the first microservice providing a functionality associated with both the first requirement and the first intent. The method further includes determining, by the architecture generator module, that a first dependency exists between the first application layer and the first microservice, and a sixth step of identifying, by the architecture generator module and with reference to a knowledge model of existing architectural solutions, a first component that enables the first dependency. In addition, the method includes generating, in response to identifying the first component that enables the first dependency, an architecture diagram that includes at least the first component and the first application layer.

In another aspect, the disclosure provides a non-transitory computer-readable medium storing software comprising instructions executable by one or more computers which, upon such execution, cause the one or more computers to generate an application architecture for a cloud computing-based infrastructure by performing the following: (1) receive, at a requirement orchestrator module, a first requirements dataset for a software application including a first requirement; (2) identify, at the requirement orchestrator module using a first machine learning (ML) model trained to determine/identify an intent(s) for a given requirement, a first intent based on the first requirement; (3) pass, from the requirement orchestrator module, the first requirement and the first intent to an architecture generator module; (4) assign, at the architecture generator module, the first requirement to a first application layer based on the first intent; (5) select, at the architecture generator module, a first microservice from a set of microservices based on the first microservice providing a functionality associated with both the first requirement and the first intent; (6) determine, by the architecture generator module, that a first dependency exists between the first application layer and the first microservice; (7) identify, by the architecture generator module and with reference to a knowledge model of existing architectural solutions, a first component that enables the first dependency; and (8) generate, in response to identifying the first component that enables the first dependency, an architecture diagram that includes at least the first component and the first application layer.

In yet another aspect, the disclosure provides a system for generating an application architecture for a cloud computing-based infrastructure, the system comprising one or more computers and one or more storage devices storing instructions that may be operable, when executed by the one or more computers, to cause the one or more computers to: (1) receive, at a requirement orchestrator module, a first requirements dataset for a software application including a first requirement; (2) identify, at the requirement orchestrator module using a first machine learning (ML) model trained to determine/identify an intent(s) for a given requirement, a first intent based on the first requirement; (3) pass, from the requirement orchestrator module, the first requirement and the first intent to an architecture generator module; (4) assign, at the architecture generator module, the first requirement to a first application layer based on the first intent; (5) select, at the architecture generator module, a first microservice from a set of microservices based on the first microservice providing a functionality associated with both the first requirement and the first intent; (6) determine, by the architecture generator module, that a first dependency exists between the first application layer and the first microservice; (7) identify, by the architecture generator module and with reference to a knowledge model of existing architectural solutions, a first component that enables the first dependency; and (8) generate, in response to identifying the first component that enables the first dependency, an architecture diagram that includes at least the first component and the first application layer.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is an overview of an embodiment of a process for an automated generation of architecture diagrams;

FIGS. 2, 3, and 4 are a sequence of schematic diagrams that collectively depict a high-level view of an architecture generation system, according to an embodiment;

FIG. 5 presents some examples of snippets of dependency graphs that can be produced by the architecture generation system, according to an embodiment;

FIG. 6 is an example of an architecture diagram generated by the proposed systems, according to an embodiment;

FIG. 7 is a flow chart depicting a method of generating an application architecture for a cloud computing-based infrastructure, according to an embodiment; and

FIG. 8 is a diagram depicting example environments and components by which systems and/or methods, described herein, may be implemented.

### DESCRIPTION OF EMBODIMENTS

Design and production of a cloud native or hybrid-cloud native application architecture has presented a significant challenge in cloud deployment project management and execution. For example, current processes rely on a design paradigm where an individual system architect can determine whether the cloud deployment will be successful and well-provisioned for adapting to the dynamic needs and requirements of an organization. The system architect can therefore ‘make-or-break’ the resilience of an architecture based on their skills and knowledge. Whether a given architect's expertise will be sufficient to comprehensively plan for and encode the needs of a given organization is difficult to ascertain or secure. There remains a strong need for an approach to cloud architecture diagram generation and provisioning that is consistently functional, robust, and valuable across most if not all intents and requirements.

The proposed systems and methods are directed to the automated, intelligent generation of a comprehensive, high-level, quality architecture diagram of a cloud application. The diagram may involve layers of complexity, including components such as servers, content delivery networks (CDNs), microservices, databases, among other components, as well as their multi-faceted interconnections. In some embodiments, the process can be triggered upon the ingestion of the system requirements, implementing an artificial intelligence (AI)-based end-to-end methodology that automatically determines the optimal arrangement and distribution of each of the components. Such an approach can standardize the mechanism by which architecture generation occurs and remove the undesirable dependency on individual human architect skillsets-which can fluctuate widely from highly knowledgeable to inappropriate or simply inadequate—for the system's success. In some embodiments, the proposed systems and methods enable automated extraction of dependencies from native architecture diagrams, as well as automated encoding of how architecture decisions are affected by user requirements, framework goals (standards), and other case-by-case architecture decisions.

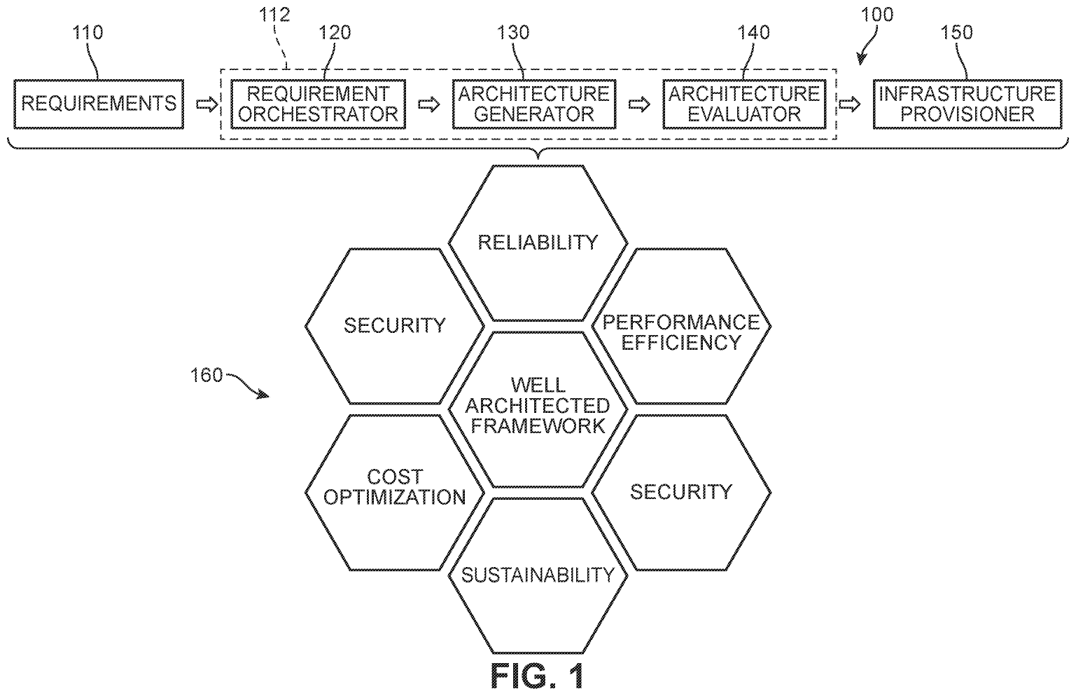

As discussed above, in different embodiments, the proposed systems and systems can generate, given specific user requirements and functionality descriptions, a tailor-made application architecture that can provide a ready-to-use foundation for application development and cloud deployment. Referring first to FIG. 1, an overview of the proposed embodiments is depicted. As shown in FIG. 1, an intelligent architecture generation process 100 (or process 100) can include the input of the user requirements 110 into an intelligent architecture design system 112 (or system 112). In different embodiments, the system 112 can be understood to include three modules: a requirement orchestrator 120, an architecture generator 130, and an architecture evaluator 140. As a general matter, the process 100 can be directed to output of an architecture design in which each software tier or layer (e.g., presentation layer, data layer, logical layer, etc.) is arranged to best suit its role/function and interrelationships within the application.

In some embodiments, the requirement orchestrator 120 can identify the requirements and requirement intents (purpose), while the architecture generator 130 can extract microservices by grouping similar and highly coupled functionalities, encode the dependencies among different architecture layers, and encode the dependencies among components of a dependent layer and its parent layers into a dependency graph that can be used to generate the final layered architecture. Furthermore, the architecture evaluator 140 can help ensure that the architecture framework incorporates each essential architectural goal or ‘pillar’ by identifying fit gaps and ensuring the final architecture abides by the pillars. For example, validation by the architecture evaluator 140 can assess the architecture framework based on standards 160 of (1) reliability, or the ability of the system to recover from failures and continue to function, (2) security, or the ability of the system to protect applications and data from threats, (3) cost optimization, or the ability of the system to enable cost management and maximize the value delivered, (4) operational excellence, or the ability of the system to support operations processes that keep a system running in production, (5) performance efficiency, or the ability of the system to adapt to changes in load, and (6) sustainability, or the ability of the system to minimize the environmental impacts of running cloud workloads. The system 112 can further include an optional infrastructure provisioner 150 in some embodiments. Each of these modules will be described in greater detail below.

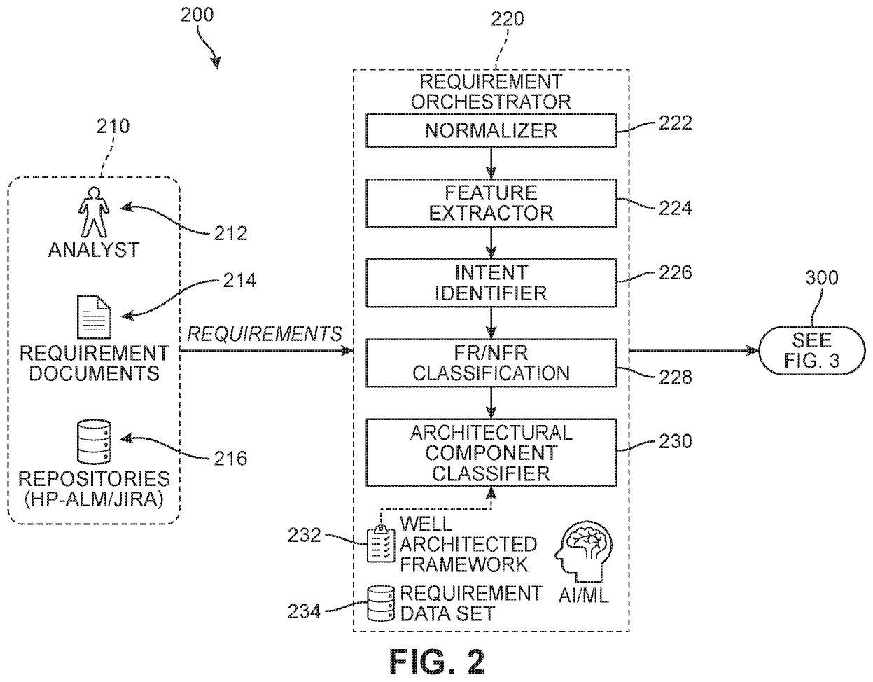

Referring now to FIGS. 2, 3, and 4, a high-level view of an embodiment of a flow through a technical system pipeline (“system”) 200, 300, and 400 for the generation of architectures for cloud computing infrastructures is shown. As noted earlier, the system can include three primary modules (requirement orchestrator, architecture generator, and architecture evaluator), as well as an optional fourth module directed to infrastructure provisioning. As a general matter, the proposed systems can provide architecture generation for cloud native application architecture generation across a variety of cloud platforms. Some examples include but are not limited to AWS®, Azure®, GCP®, Oracle®, and others. In addition, embodiments of the proposed system can be built using a wide range of programming languages, including but not limited to Python, Go, Ruby, Java or C.Net.

As shown in FIG. 2, a requirement orchestrator 220 of the system can initially receive inputs 210 including descriptions of the requirements from multiple sources (e.g., in the form of requirement documents 214, analyst evaluations 212, and knowledge about the organization related to the software and its management in data repositories 216). In some other embodiments, requirements documentation can include organizational/business requirements, functional requirements, use cases, user stories, and so forth. In one example, requirements capture or represent information related to the business process(es) that will be supported by the software, intended actions that will be performed through the software, managed data, rule sets, non-functional attributes (e.g., response time, accessibility, access and privilege, etc.), and so forth.

In different embodiments, data from these inputs 210 can be passed to a normalizer 222 of the requirement orchestrator 220, which performs normalization of the data to reduce errors and provide consistency. In some embodiments, normalization of inputs may include, for example, converting words to their root forms (i.e., stemming), embedding words to numerical space, and/or correcting misspelled words. Normalization of inputs can help make the downstream task of intent generation from the requirements in the inputs easier and more robust.

In some embodiments, the processed or normalized information is then passed to a feature extractor 224, which can generate or extract features, and may utilize artificial intelligence (e.g., machine learning, data mining, and/or the like), to identify features pertinent to intent and requirement analysis that will be performed by intent identifier 226. Intents can refer to the goal of the stakeholders in terms of what the software application product needs to do, and/or what the intended use of a specific software feature is in operation. In one example, intent is high-level, bypassing the details and moves focus to the “why” and “what” of a particular feature/function of the software, while requirements are more low-level and describes a “how” of that feature/function. Put another way, intent ‘zooms out’ on the big-picture forest while requirements ‘zoom into’ the detail trees. In one example, low-level requirements are closer to technical details while high-level intent is closer to the software's goals. Thus, the proposed system allows for automatic determination of an intent based on the inputted requirement. This is important because specifying only the outcome is insufficient for crafting a sustainable and well-managed architecture—the requirement must be paired with a rationale (intent) for context to ensure the appropriate selection of components and layers.

In different embodiments, feature extraction may involve one or more of a variety of data extraction methodologies to extract the features from the processed information or raw information, such as extracting information into flat files using a structured query language (SQL), extracting information into flat files using a program, exporting information into export files, logical extraction or rule mining methodologies (e.g., a full extraction method, an incremental extraction method, and/or the like), physical extraction methodologies (e.g., an online extraction method, an offline extraction method, and/or the like), an entity extraction method (e.g., also called an entity identification method, an entity chunking method, or a named-entity recognition (NER) method), a string matching method, and/or the like.

The extracted features (e.g., the feature set) can then be received by the intent identifier 226, which determines intents from the inputted user requirements. In some embodiments, the intent identifier 226 can employ an artificial intelligence (AI) and/or machine learning (ML) model to take the generated feature sets as input and determine which intents are most likely to represent the input. In different embodiments, AI model may include one or more of a lasso regression model, a random forest model, a support vector machine model, an artificial neural network model, a data mining model, a frequent rule mining model, a pattern discovery model, and/or the like, as described elsewhere herein.

In some embodiments, the identified intents outputted by the intent identifier 226 can then be categorized as corresponding to either a functional requirement (FR) type or a non-functional requirement (NFR) type via an FR/NFR classification module 228. This classification allows for the separation of data that identifies the requirements that need non-functional attributes (e.g., quality attributes) and may be generic, and requirements that need functional attributes (e.g., operational attributes) and may be project-specific. An architectural component classifier 230 can then classify the outputted requirements into one or more of a plurality of pillars or standards of a well architected framework 232. In some embodiments, the architectural component classifier 230 can classify each requirement into one or more of six standards, described earlier with reference to FIG. 1. In other embodiments, there may be alternate or additional standards that can be defined and applied as classification labels. In some embodiments, the data can also be stored as a requirement data set 234 for subsequent use by other modules of the system. In addition, in some embodiments, the system can determine during a feed-gap analysis, that there is a pillar which has not been addressed by the submitted requirements, such as security, and automatically return a request to the submitter or analyst to confirm the absence of such requirement(s), and whether the system should automatically generate intents based on the missing pillar/standard.

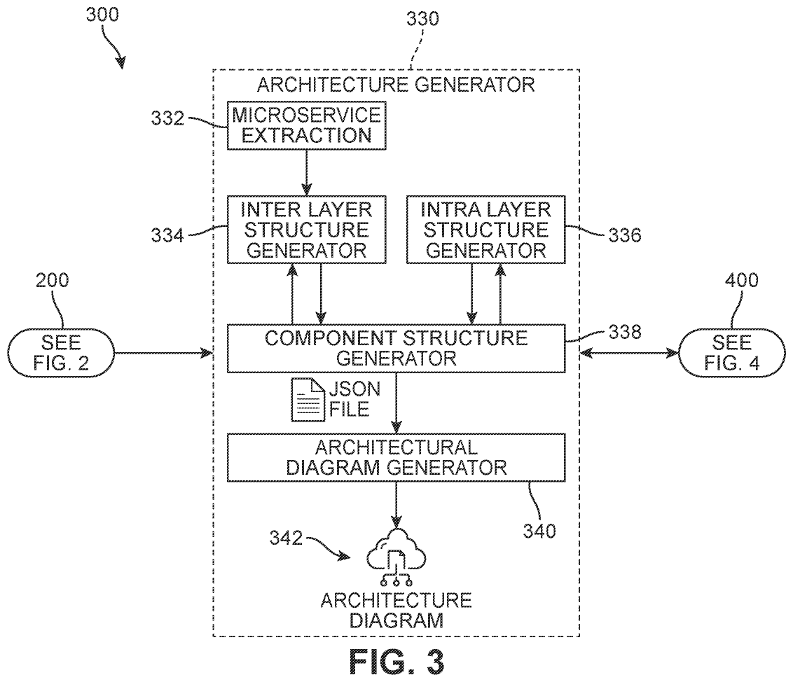

Moving now to FIG. 3, the output of the requirement orchestrator 220 of FIG. 2 can be passed to an architecture generator 330. In some embodiments, a component structure generator 338 of the architecture generator 330 can receive the prepared requirement data set and manage the flow of data to ultimately facilitate the generation of an architectural diagram 342 by an architectural diagram generator 340. In one example, component structure generator 338 can—given a set of user intents and requirements—generate the most probable or appropriate component diagram. In another example, component structure generator 338 can generate layered components in a specific sequenced layered structure (e.g., directed acyclic graphs or DAGs, or other conceptual representations of the series of data). In another example, the component structure generator 338 can use individual layer structure generation and inter-layer structure information to generate most probable component diagram.

In different embodiments, component structure generator 338 can work in conjunction with the associated modules of requirement orchestrator 220 to process the classified requirements data for formulation of the architecture diagram 342. For example, the requirement orchestrator 220 can perform operations including (1) extracting, via a microservice extraction module 332, one or more microservices by grouping similar and highly coupled functionalities into the same microservice; (2) generating, via an inter-layer structure generator 334, the dependencies among different layers of the layered architecture and producing a first dependency graph; (3) generating, via an intra-layer structure generator 336, the dependencies among the multiple components of each architecture layer and the requirement intents and producing a second dependency graph; and (4) inferencing the dependency graphs, via the component structure generator 338, for architecture generation by identifying the most probable components in each layer.

This data can then be passed to architectural diagram generator 340 for generation of the architecture diagram 342. In one example, the architecture diagram is generated automatically in response to receiving this data. In some embodiments, the architecture diagram 342 can represent a blueprint for developers to develop the software application that indicates not only what components or other resources are needed to successfully deploy an application supporting the given requirements in the cloud, but how much or how many (e.g., a range or a minimum) of each resource should be included, or suggestions that accommodate different client cost limits by balancing the amount of resources between functionality/sustainability and cost. Additional details regarding these modules are provided below.

In different embodiments, the microservice extraction module 332 can, given the functionality requirements and intents, extract the set of most probable microservices. Thus, as one non-limiting example, if authentication is needed for logging or registering through email or phone number using the application, the microservice extraction module 332 would determine an OTP validation microservice would be required. In some embodiments, microservice extraction module 332 clusters the given functionalities based on the word/sentence embeddings and other natural language processing (NLP) techniques. In such cases, each cluster forms a set of functionalities that are deemed ‘similar’ and thus have high degree of dependency between them, indicating to the microservice extraction module 332 that the set of microservices should be coupled. In some embodiments, the microservice extraction module 332 can apply a label or tag name that summarizes all of the functionalities in one cluster.

Furthermore, in different embodiments, inter-layer structure generator 334 can extract direct and indirect dependencies of how the components in one layer affect other layer components (referred to herein as “inter-layer relations”), including but not limited to scaled data, big data, structured or unstructured data, which can each affect the type of database that will be selected for implementation in a given data layer. In some embodiments, the inter-layer structure generator 334 can extract dependencies between components of different layers, to obtain a dependency graph over multiple layers. In different embodiments, these layers can include a presentation layer, a logical layer, and a data layer, each supporting external services. In general, the presentation layer is responsible for presenting the data to the application layer (e.g., including some form of format or character translation), the data layer manages the physical storage and retrieval of data, and the logical layer maintains organizational rules and logic.

In different embodiments, techniques based on probabilistic modelling can be used by inter-layer structure generator 334 to generate a probabilistic graph (such as a DAG). Extraction of dependencies for presentation in a dependency relations graph addresses the optimization problem of simultaneously seeking to maximize the likelihood of the data being represented in the graph structure while favoring simpler structures over complex ones. In one example, the result of this step is a DAG over the layers that represents the dependencies between different layers. Dependencies can then be encoded between the layers, thereby abstracting away the component dependencies. For example, component dependencies abstracted away can be encoded based on a conditional probability distribution. In one example, the distribution can be represented by P (c1|C2), where c1 is a component while C2 is the subset of components as per the dependency relations.

Similarly, the intra-layer structure generator 336 can extract direct and indirect intra layer dependencies, and define latent nodes for simplistic representations and incomplete or unobservable data (e.g., latency and static content that can indicate the requirement of the presence of CDNs, etc.). More specifically, the intra-layer structure generator 336 can extract dependencies among components and intents for each layer, including how the architecture components may be affected by other components and requirement intents. In one example, the dependency graph produced by the intra-layer structure generator 336 encodes the dependency between the layer components, user intents, and parent layer and child layer components based on probabilistic modelling techniques. As noted above, extraction of dependencies in a dependency relations graph addresses the optimization problem of simultaneously seeking to maximize the likelihood of the data being represented in the graph structure while favoring simpler structures over complex ones. In some embodiments, the intra-layer structure generator 336 further optimize the dependencies' structure by extracting the hidden representations that simplify the graph structure while retaining most of the dependencies. In some embodiments, a cloud architect may provide feedback for the dependency graph, and in some cases, known dependencies could be added and/or spurious dependencies could be removed based on such feedback. In one embodiment, intra-layer structure generator 336 can generate a DAG for each layer that represents the dependencies among its (a) components, (b) intents, and (c) parent layer components, as per layered structure dependency graph. In some embodiments, the conditional probability distributions over components and intents with respect to the generated dependency graph can be obtained. For example, the distribution can be represented by P (c1|C2, l1), where c1 is a component, C2 is a subset of components, and l1 is a subset of intents.

In different embodiments, the inferencing process of the two types of dependency graphs (outputted by inter-layer structure generator 334 and intra-layer structure generator 336) can be performed by the component structure generator 338 using one or more machine learning and AI techniques. Inferencing refers to the process by which the component structure generator 338 evaluates each of the dependencies in the graphs, and based on the dependencies identified, selects which components are needed. For example, the component structure generator 338 can generate—in a topologically sorted order (first layer L1, second layer L2, third layer L3, and so forth) with respect to the layered structure of the dependency graph—the inferenced components for each layer. In one example, where a dependency graph has layers (L1, L2, L3, . . . ), based on the user requirements and intents, the most probable components are generated for layer L1, the most probable components are generated for layer L2, and the most probable components are generated for layer L3. In other words, the component structure generator 338 can first select components for the logical layers and presentation layers before the external layer because the external layer depends on those two layers. Similarly, once components have been generated for the three layers, components for the data layer can be selected because the data layer depends on those three layers.

It can be understood that in determining what layers and components should be included in the dependency graphs, the system can make use of or reference (or otherwise access) a knowledge graph or knowledge model that represents the existing architectural solutions, options, and features that are available. This knowledge may be an internal repository, and/or be provided via an external source. In some embodiments, the knowledge graph can be an ontology of cloud computing architecture that defines and describes design, drafting, component and layer interrelationships and dependencies, microservices, cloud service provider options, and provisioning. In one example, one or more templates for an architectural diagram may also be provided as a building block from which the system can modify or add components.

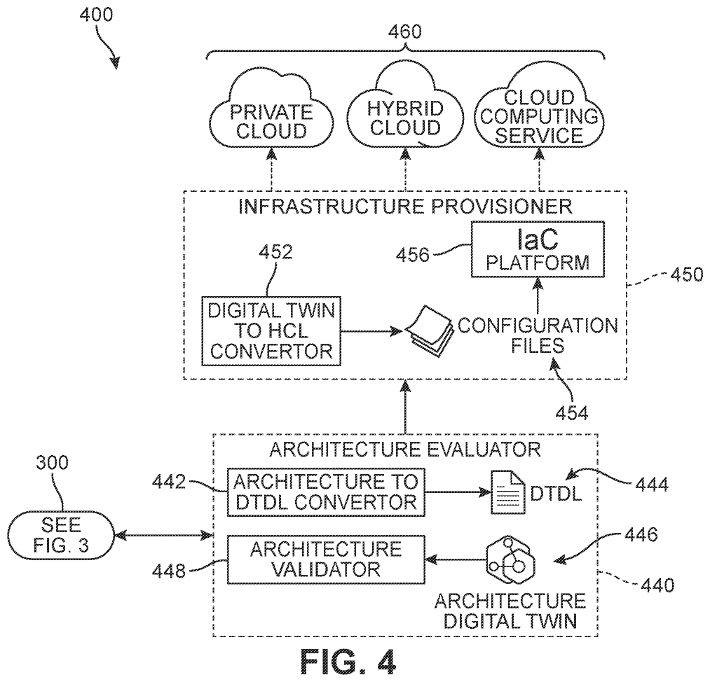

In a next stage, depicted in FIG. 4, the architecture diagram 342 of FIG. 3 is passed to an architecture evaluator 440, which is responsible for evaluating the proposed or draft architecture against one or more service level agreements (SLAs) as well testing the rigidity of the architecture against various test scenarios. For example, the output (feedback) of an architecture validator 448 can be passed back to the architecture generator 330 to enable validation of the output of the architecture generator's dependency graphs and local parameters based on the architecture evaluator's feedback.

In some embodiments, the architecture evaluator 440 can implement a digital twin technique using a digital twins definition language (DTDL) to provide feedback. For example, the architecture diagram can be processed by an architecture-to-DTDL converter 442 to produce a DTDL-based ontology 444, which is used to obtain an architecture digital twin 446 of the proposed architecture diagram. In some embodiments, architecture digital twin 446 enables the system to simulate various scenarios to test the strength of the architecture before finalization of the diagram. This approach allows for a more comprehensive validation of the output. For example, the simulation can be used to determine whether all of the SLA factors have been addressed by the given components and layers. In some embodiments, the architecture digital twin 446 can be configured to introduce new components or edit existing components to the proposed architecture to validate and/or enhance the architecture. In one example, architecture digital twin 446 can capture the various components of the architecture as nodes and establish the relations between them. In some embodiments, architecture digital twin 446 can be enriched with various metadata which can be used to evaluate various test scenarios. As a general matter, metadata can refer to data that describe the properties or characteristics of data and the context of those data. For example, if the proposed architecture indicates a CDN should be included in order to address a latency concern associated with the application, the digital twin can be used to validate if the proposed CDN effectively solves the concern by calculating the time lapsed in between a page being rendered using a CDN against the same without using the CDN. Many more such test cases can be constructed and using a digital twin-based evaluation technique to accurately substantiate or enhance the proposed architecture diagram.

In different embodiments, once the architecture diagram has been validated and, in some cases, enhanced, augmented, or otherwise improved by the architecture evaluator 440, the data can be passed to an infrastructure provider 450. In some embodiments, the infrastructure provider 450 can facilitate and/or automate the provisioning of the infrastructure requirements in a multi-cloud environment as defined by the generated architecture diagram. In some embodiments, infrastructure resource provisioning in cloud can be done with “Infrastructure as Code” (IaC) tools such as Terraform®, Chef®, Ansible®, Helm®, AWS CloudFormation®, Azure Resource Manager®, Google Cloud Deployment Manager®, etc. In general, IaC encompasses the management and provisioning of cloud resources through code, rather than through manual processes and can be used to set up complex infrastructure in a cloud environment. Thus, IaC techniques can be understood to describe the specifications of required infrastructure (e.g., VMs, storage, networking, and others configurations) in text form as ‘Code’. In other words, IaC is a process of managing and provisioning cloud infrastructure through machine-readable definition files, rather than physical hardware configuration or interactive configuration tools. IaC can be versioned and used to deploy cloud environments independently. This code is then used as a basis for provisioning cloud infrastructure resources in a targeted cloud platform. The platform can be implemented as a single or multi-cloud environment.

It can be appreciated that the use of IaC techniques offer many advantages, including reductions in cost, improved speed to deployment, and decreased risk. The use of IaC drastically reduces the amount of human resource required to provision and mange cloud resources. Infrastructure provisioning through code also significantly improves the speed at which provisioning of resources across the cloud can occur compared to traditional methods. Furthermore, as the code can be automatically versioned, reviewed, and documented, the risk of defects or leakage is significantly reduced relative to the traditional manual approach. In one example, a digital twin to HCL converter 452 can be used to convert the digital twin file (e.g., in JSON, CSV, YAML, Excel®, or other data file format format) into an IaC-based configuration file (e.g., HCL) which can then be passed to an IaC platform (e.g., Terraform) to provision the required infrastructure in a cloud environment 460 (e.g., associated with cloud computing services such as AWS®, Google® Cloud, etc.).

Thus, as described herein, embodiments of the proposed systems and methods are configured to perform a sequence of complex tasks that can ingest a set of requirements and associated descriptions and intelligently select the most probable microservices that correspond to said requirements. Those functionalities that are ‘similar’ and have high degree of dependency are clustered together and recommended to fall under the same microservice. In addition, in some embodiments, the systems approach the component selection process by reference to a layered structural that generates the dependency graph with the assumption that each component in a layer forms a group. In other words, if one data layer component depends on a few of the logical layer and external layer components, it is determined that there must be a dependency relation extending from the logical and external layer to the data layer. The structure generation algorithms (e.g., maximum likelihood estimation (MLE), maximum a posteriori probability (MAP), Bayesian estimations, etc.) can ensure that the generated dependency graphs are DAG-based, as inferences are not possible or feasible on a cyclic dependency graph. Thus, once the dependency graph structures are generated, the exact relation between component values can be inferenced, including how much of one component should be included to accommodate the requirement and intent. As a non-limiting example, if w are the weights, and the dependent variable (e.g., the number of regions and locations) y can be decided based on X=user locations, latency, and availability requirements, Equation (1) below can be used to identify the relationship between components in the dependency graph based on the distribution parameters (e.g., input to output mapping).

$$P ( y \vert X = x ) = 𝒩 ( {w}_{0} + {w}^{T} x ; {σ}^{2} ) ; X = 〈 {X}_{1} , {X}_{2} , … {X}_{k} 〉 \qquad Equation ( 1 )$$

In some embodiments where the distribution is continuous, the distribution on y could be Gaussian, with the mean based on a linear combination of parent nodes. In this case, the network could learn the corresponding weights and variance. Where the distribution is discrete, the corresponding discrete distribution could be learned from data using the principals of parameter estimation methods such as MLE, MAP, and Bayesian estimation, or similar techniques. Given the parent components (X) values, the value of the component (y) can be inferenced using Equation (1) above for the continuous case.

Furthermore, in some embodiments, the inter-layer component dependencies are abstracted away for generation of layered structure dependency graph, and are later used for generating the component structure dependency graph. In one example, individual layer structures are generated in topological order based on the layered structure dependency graph. These structures encode the dependencies between components of (a) that layer, (b) requirement intents, and (c) parent layer components (e.g., how one or more components and requirement intents affect other components). This process is designed to break down structure generation into relatively smaller and easy subtasks. In one embodiment, the final dependency graph can be inferenced to generate the most probable architecture components.

For purposes of illustration, one example of an architecture diagram generation process using the proposed systems and methods is now described. For this example, a set of sample requirements is introduced. These requirements should not be understood to limit the performance of the described systems and methods, and alternate or additional requirements may also be provided.

### Sample Requirements:

1. The application should be available in both mobile as well as a responsive web app.

2. The e-commerce store should be able to maintain large product catalogue which customer can browse and purchase

3. Customer should be able to view order status and history as well maintain product of interest to his cart.

4. The e-commerce store should be able to maintain state for users, orders and workflow in the event of failures.

5. The e-commerce store has fluctuating web traffic, depending on seasonality and marketing efforts.

6. Each tier should be resilient to failures, with no noticeable impact to end-user.

7. All static content such as product images and details should be available to the user without any delay.

8. The e-commerce store needs to authenticate user prior to order placement. The e-commerce sites should be able to deliver authenticated and unauthenticated content to the user.

9. Users of the e-commerce store should be able to perform multiple type of search including full text searches, structured searches, unstructured searches, and geo-searches. The searches should be probably be AI driven.

10. The e-commerce store should be able to cater to multiple regions and ensure that all the regions are synchronized appropriately.

11. The e-commerce store should enable users to purchase products online using multiple external payment services.

12. The e-commerce store should be capable of continuously evolving and bringing in new features or updates.

13. The e-commerce store should be able to send notifications to customers and partners on order and account matters.

14. The e-commerce store should be able to recommend user products based on various criteria such as their interests, previous search history, and sales and discounts and other offers, etc.

15. The e-commerce store should be able to collect and process data for analysis such as time spent by users on various pages/products, buying and/or abandoning behavior, demographic preferences and behavior, marketing analytics, etc.

16. The e-commerce store should be able to communicate with inventory management systems to show customers available products, and provide logistics and shipping information to facilitate shipment of the order to customers and manage returns.

17. All customer related information should be maintained by external CRM utility.

As described earlier, an initial operation performed by the FR/NFR classification module of the requirement orchestrator is classifying the requirements based on their functional status. In this example, three items are identified as non-functional requirements, including item (5), item (6), and item (7), while the remaining items listed fall under functional requirements. More specifically, item (5) may be determined to fall under a well-architected framework standard of sustainability, item (6) may be determined to fall under a well-architected framework standard of operational excellence, and item (7) may be determined to fall under a well-architected framework standard of performance efficiency.

Similarly, intent identification can be performed, whereby each remaining item is assigned a most probable intent. Some non-limiting examples of intents as derived by the requirement orchestrator for each requirement item are listed here:
(a) Multiple Device Support—Item (1)
(b) Large Data Storage—Item (2)
(c) Data Persistence—Item (3)
(d) Stateful—Item (4)
(e) Scalable—Item (5)
(f) Reliable—Item (6)
(g) Latency Sensitive—Item (7)
(h) Authentication—Item (8)
(i) Fast and Complex Search Capability—Item (9)
(j) Multi-Region—Item (10)
(k) Payment Service—Item (11)
(l) Continuous Development—Item (12)
(m) Notifications—Item (13)
(n) Recommendation—Item (14)
(o) Data Analytics—Item (15)
(p) Inventory Management—Item (16)
(q) CRM—Item (17)

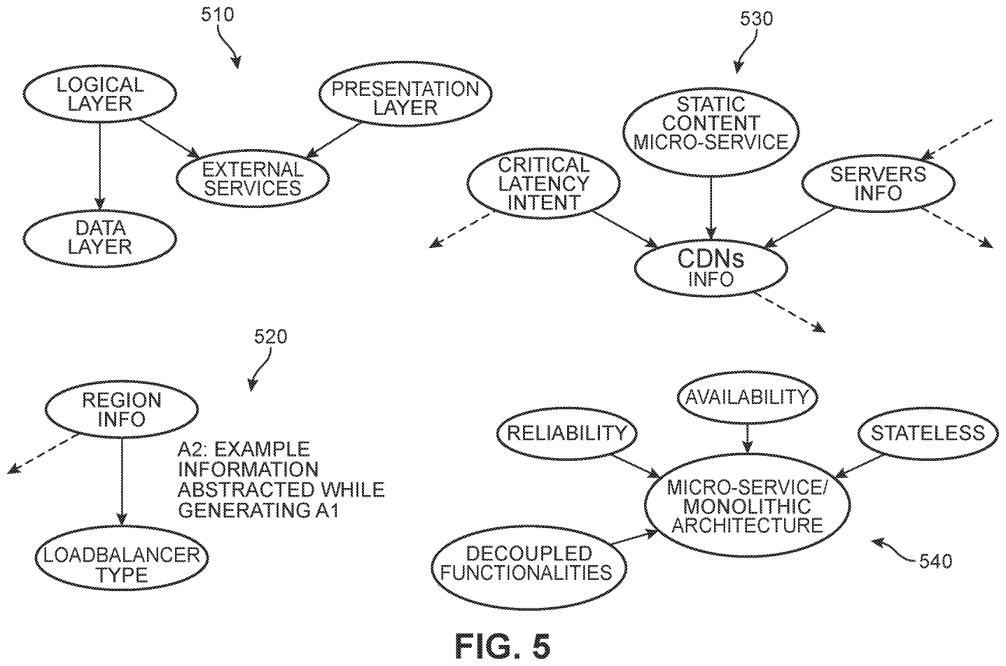

In different embodiments, once the requirement orchestrator has processed the requirements as described above, the architecture generator can receive the classified requirements data set from this example and perform dependency graph structure generation. With respect to the above sample data, the architecture generator can produce multiple dependency graphs, some example portions (or “snippets”) of which are shown in FIG. 5. For example, a first dependency graph 510 depicts how the different layers can interact with each other and external services, representing an inter-layered structure graph snippet. In this case, logical and presentation layer components are generated followed by external services and data layer components. A second dependency graph 520 depicts example information (region info) that can be abstracted during the process of generating the first dependency graph 510. In some embodiments, an inter-layer dependency graph (e.g., second dependency graph 520) may be understood to represent an encoding of user requirements. In this case, second dependency graph 520 encodes the region information (e.g., the number of regions, locations, etc.) that may depend on the user's information (e.g., user locations, user concentration, etc.) along with user requirement intents (e.g., scalability, availability, latency, etc.). For example, Equation (1) (see above) can be used to represent the dependency relation between the number of users, their concentration in different locations, latency requirements, and availability requirements with the region information and server information (e.g., number, service provider, type, etc.). Once the logical layer components and presentation layer components are generated, they are used as evidence or references, along with the user requirements, to generate the most probable external services components. For example, if the application includes a requirement of tracking the user or product location, then the system can determine that an external location service is the most probable service component required. The exact location service identified or selected by the system may also depend on the location of servers, reliability, and availability requirements. In some embodiments, requirement intents (e.g., payment service, user and product information storage, static content storage, etc.) may be used by the system to determine the which database should be recommended. The exact type of database identified or selected by the system may also depend on scalability requirements, structure of data, etc.

In addition, a third dependency graph 530 depicts an example of an intra-layer structure graph snippet, in this case for a logical layer. This type of graph can be based on extraction of the dependencies between different architecture components and intents. A fourth dependency graph 540 depicts a graph snippet that shows the coupling between the identified user intents such as reliability, availability, and stateless architecture preferences, along with a selected level of decoupling among functionalities, which can impact the decision of a microservice-based approach or monolithic-based approach in the architecture. For example, adding an item to cart, removing items from the cart, rechecking cart items availability, rechecking cart items price/info would be deemed ‘similar’ functionalities, which are tightly coupled and can therefore be grouped in the microservice tagged by the label “Cart”. Once the system defines the microservices for the logical layer, the other architecture components can also be generated in a topologically-sorted order with respect to the layered structure dependency graph.

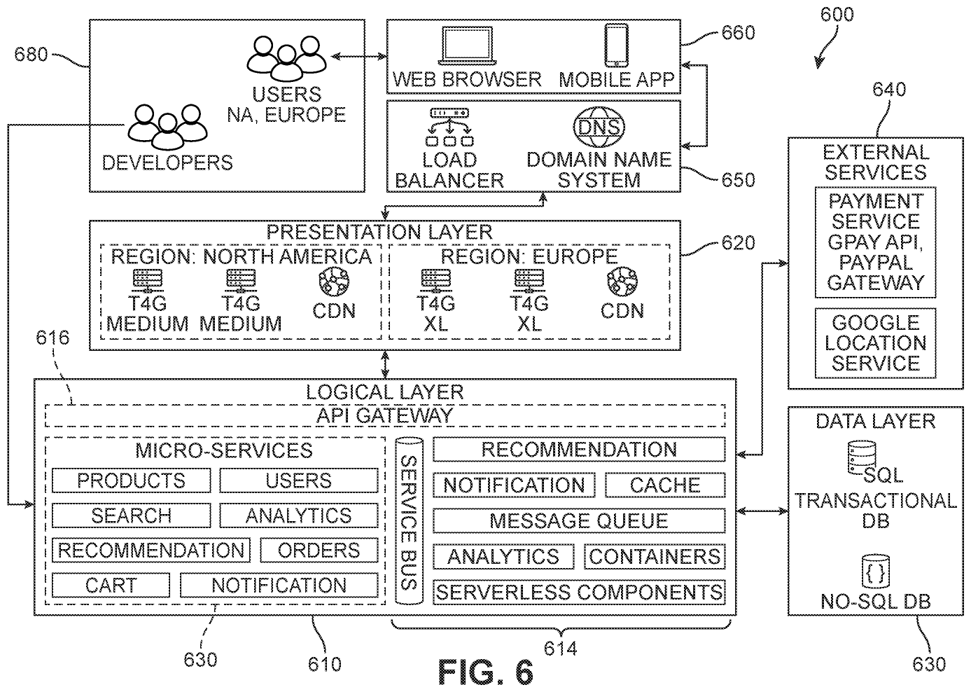

Moving now to FIG. 6, an example of a sample architecture diagram 600 that can be automatically generated by embodiments of the proposed systems is presented. The system has automatically drafted a schematic that includes multiple layers and components that have been selected to target or address each of the inputted user requirements and intents. In this example, a logical layer 610 is shown in which microservices 612 and components 614 are identified that can, via an API gateway 616, support the operations of a presentation layer 620 (e.g., including resources for two regions). A data layer 630 is also depicted supporting and storing the flow of data. External services 640 are included as well, ensuring appropriate payment and location services are available. In addition, web features and resources 650 to enable service to users 680 across different devices 660 are provided.

The proposed embodiments remove the presence of manual errors, and allow for an accelerated cloud application development and cloud deployment paradigm that can be tested and validated prior to actual ‘live’ deployment by reference to AI-generated digital twin architectures. Thus, any errors will not lead to any real-world harm. By providing a route by which custom-designed well-architected frameworks can be automatically generated and evaluated without the need for variable human skillset-dependent selections, the quality and consistency of the cloud deployment is also greatly enhanced. Similarly, the use of a digital twin in validation leads to significant reductions in defect leakage across various testing phases. In addition, the digital twin enables significant acceleration in the execution of testing operations due to the resulting reduction in defect management overhead-any errors are propagated at the digital twin model, rather than a real-world deployed cloud application. Furthermore, in different embodiments, the results of the validation and associated feedback from reviewers or other testers can be sent back to the architecture generator module to iteratively (e.g., with each round of feedback) improve the accuracy of their ML model outputs (e.g., providing a continuous feedback loop) by self-learning.

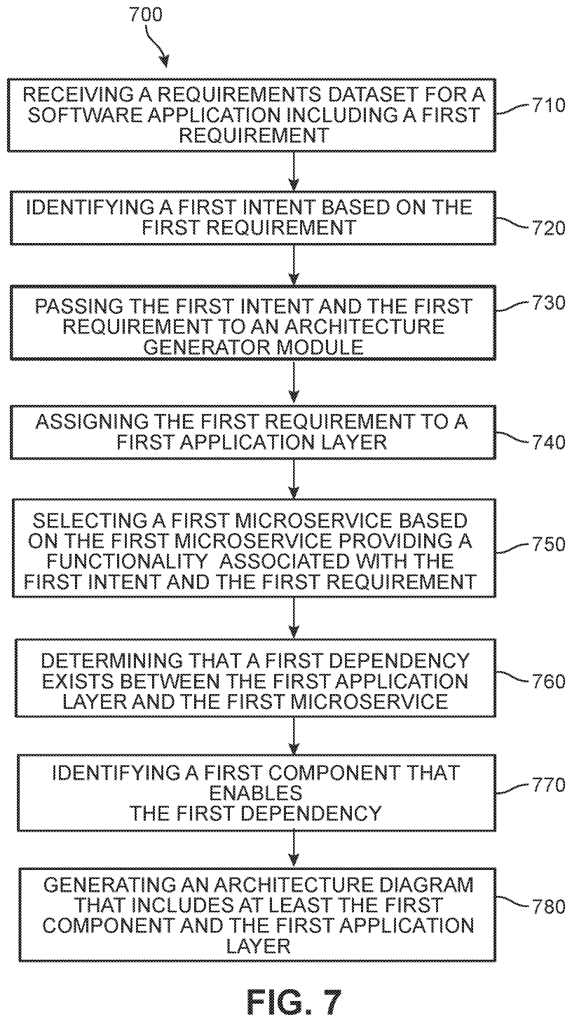

FIG. 7 is a flow chart illustrating an embodiment of a method 700 of generating an application architecture for a cloud computing-based infrastructure. The method 700 includes a step 710 of receiving, at a requirement orchestrator module, a first requirements dataset for a software application including a first requirement, and a step 720 of identifying, at the requirement orchestrator module using a first machine learning (ML) model trained to determine an intent(s) for a given requirement, a first intent based on the first requirement. The method 700 also includes a step 730 of passing, from the requirement orchestrator module, the first requirement and the first intent to an architecture generator module. The method includes a step 740 of assigning, at the architecture generator module, the first requirement to a first application layer based on the first intent. The method includes a step 750 of selecting, at the architecture generator module, a first microservice from a set of microservices based on the first microservice providing a functionality associated with both the first requirement and the first intent. The method 700 further includes a step 760 of determining, by the architecture generator module, that a first dependency exists between the first application layer and the first microservice, and a step 770 of identifying, by the architecture generator module and with reference to a knowledge model of existing architectural solutions, a first component that enables the first dependency. In addition, a step 780 includes generating, in response to identifying the first component that enables the first dependency, an architecture diagram that includes at least the first component and the first application layer.

In other embodiments, the method may include additional steps or aspects. In some embodiments, the method also includes generating, using probabilistic modeling, a first dependency graph that encodes dependencies between two or more application layers of the software application, where determining that a first dependency exists between the first application layer and the first microservice is based in part on the first dependency graph. In another example, the first requirements dataset can also include a second requirement, and the method can further include identifying, at the requirement orchestrator module, a second intent based on the second requirement, determining the first intent and the second intent are directed to the same goal, and coupling the first requirement with the second requirement.

In one embodiment, selection of the first microservice is further based on the coupling of the first requirement with the second requirement. In some embodiments where the first requirements dataset also includes a second requirement, the method can also include steps of identifying, at the requirement orchestrator module, a second intent based on the second requirement, selecting, at the architecture generator module, a second microservice from the set of microservices based on the second microservice accommodating a second goal associated with the second intent, determining, by the architecture generator module, that a second dependency exists between the first application layer and the second microservice, and identifying, by the architecture generator module, a second component as representing the most probable component for enabling the second dependency.

In some embodiments, the first intent is based on one of a reliability standard, a security standard, a cost optimization standard, an operational excellence standard, a performance efficiency standard, and a sustainability standard. In one example, the method also includes assigning, at the architecture generator module, the first requirement to a first application layer based on the first intent, the first application layer being one of a presentation layer, data layer, and a logic layer. In different embodiments, the method further includes generating, at an architecture evaluator module, a digital twin model of the architecture diagram, and simulating a first scenario to evaluate a performance of the digital twin model with respect to the first intent (high-level goal/purpose). In some embodiments, the method also includes automatically provisioning the cloud computing-based infrastructure based on the architecture diagram.

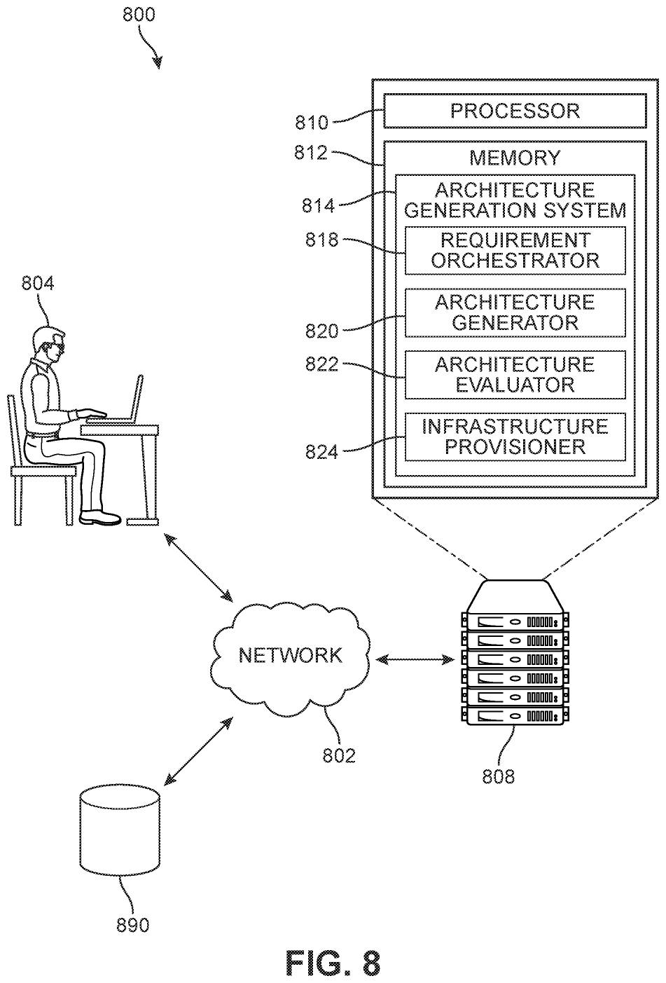

FIG. 8 is a schematic diagram of an environment 800 for an intelligent architecture generation system 814 (or system 814), according to an embodiment. The environment 800 may include a plurality of components capable of performing the disclosed methods. For example, environment 800 includes a user device 804, a computing/server system 808, and a database 890. The components of environment 800 can communicate with each other through a network 802. For example, user device 804 may retrieve information from database 890 via network 802. In some embodiments, network 802 may be a wide area network (“WAN”), e.g., the Internet. In other embodiments, network 802 may be a local area network (“LAN”).

As shown in FIG. 8, components of the system 814 may be hosted in computing system 808, which may have a memory 812 and a processor 810. Processor 810 may include a single device processor located on a single device, or it may include multiple device processors located on one or more physical devices. Memory 812 may include any type of storage, which may be physically located on one physical device, or on multiple physical devices. In some cases, computing system 808 may comprise one or more servers that are used to host the system.

While FIG. 8 shows one user device, it is understood that one or more user devices may be used. For example, in some embodiments, the system may include two or three user devices. In some embodiments, the user device may be a computing device used by a user. For example, user device 804 may include a smartphone or a tablet computer. In other examples, user device 804 may include a laptop computer, a desktop computer, and/or another type of computing device. The user devices may be used for inputting, processing, and displaying information. Referring to FIG. 8, environment 800 may further include database 890, which stores test data, training data, metadata, design data, classification data, attribute data, feedback data from the architecture evaluator module for iterative improvements to the AI/ML models (architecture generator module), relationship data, and/or other related data for the components of the system as well as other external components. This data may be retrieved by other components for system 814. As discussed above, system 814 may include a requirement orchestrator module 818, an architect generator module 820, an architecture evaluator module 822, and an infrastructure provisioner module 824. Each of these modules/components may be used to perform the operations described herein.

For purposes of this application, an “interface” may be understood to refer to a mechanism for communicating content through a client application to an application user. In some examples, interfaces may include pop-up windows that may be presented to a user via native application user interfaces (UIs), controls, actuatable interfaces, interactive buttons/options or other objects that may be shown to a user through native application UIs, as well as mechanisms that are native to a particular application for presenting associated content with those native controls. In addition, the terms “actuation” or “actuation event” refers to an event (or specific sequence of events) associated with a particular input or use of an application via an interface, which can trigger a change in the display of the application. Furthermore, a “native control” refers to a mechanism for communicating content through a client application to an application user. For example, native controls may include actuatable or selectable options or “buttons” that may be presented to a user via native application UIs, touch-screen access points, menus items, or other objects that may be shown to a user through native application UIs, segments of a larger interface, as well as mechanisms that are native to a particular application for presenting associated content with those native controls. The term “asset” refers to content that may be presented in association with a native control in a native application. As some non-limiting examples, an asset may include text in an actuatable pop-up window, audio associated with the interactive click of a button or other native application object, video associated with the user interface, or other such information presentation.

It should be understood that the text, images, and specific application features shown in the figures are for purposes of illustration only and in no way limit the manner by which the application may communicate or receive information. In addition, in other embodiments, one or more options or other fields and text may appear differently and/or may be displayed or generated anywhere else on the screen(s) associated with the client's system, including spaced apart from, adjacent to, or around the user interface. In other words, the figures present only one possible layout of the interface, and do not in any way limit the presentation arrangement of any of the disclosed features.

Embodiments may include a non-transitory computer-readable medium (CRM) storing software comprising instructions executable by one or more computers which, upon such execution, cause the one or more computers to perform the disclosed methods. Non-transitory CRM may refer to a CRM that stores data for short periods or in the presence of power such as a memory device or Random Access Memory (RAM). For example, a non-transitory computer-readable medium may include storage components, such as, a hard disk (e.g., a magnetic disk, an optical disk, a magneto-optic disk, and/or a solid state disk), a compact disc (CD), a digital versatile disc (DVD), a floppy disk, a cartridge, and/or a magnetic tape.

To provide further context, in some embodiments, some of the processes described herein can be understood to operate in a system architecture that can include a plurality of virtual local area network (VLAN) workstations at different locations that communicate with a main data center with dedicated virtual servers such as a web server for user interfaces, an app server for data processing, a database for data storage, etc. As a general matter, a virtual server is a type of virtual machine (VM) that is executed on a hardware component (e.g., server). In some examples, multiple VMs can be deployed on one or more servers.

In different embodiments, the system may be hosted at least in part in a cloud computing environment offering ready scalability and security. The cloud computing environment can include, for example, an environment that hosts the document processing management service. The cloud computing environment may provide computation, software, data access, storage, etc. services that do not require end-user knowledge of a physical location and configuration of system(s) and/or device(s) that hosts the policy management service. For example, a cloud computing environment may include a group of computing resources (referred to collectively as “computing resources” and individually as “computing resource”). It is contemplated that implementations of the present disclosure can be realized with appropriate cloud providers (e.g., AWS provided by Amazon™, GCP provided by Google™, Azure provided by Microsoft™, etc.).

The methods, devices, and processing described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A computer-implemented method of generating an application architecture for a cloud computing-based infrastructure, the method comprising:
receiving, at a requirement orchestrator module, a first requirements dataset for a software application including a first requirement;
identifying, at the requirement orchestrator module using a first machine learning (ML) model trained to determine/identify an intent(s) for a given requirement, a first intent based on the first requirement;
passing, from the requirement orchestrator module, the first requirement and the first intent to an architecture generator module;
assigning, at the architecture generator module, the first requirement to a first application layer based on the first intent;
selecting, at the architecture generator module, a first microservice from a set of microservices based on the first microservice providing a functionality associated with both the first requirement and the first intent;
determining, by the architecture generator module, that a first dependency exists between the first application layer and the first microservice;
identifying, by the architecture generator module and with reference to a knowledge model of existing architectural solutions, a first component that enables the first dependency; and
generating, in response to identifying the first component that enables the first dependency, an architecture diagram that includes at least the first component and the first application layer.

2. The method of claim 1, further comprising generating, using probabilistic modeling, a first dependency graph that encodes dependencies between two or more application layers of the software application, wherein determining that a first dependency exists between the first application layer and the first microservice is based in part on the first dependency graph.

3. The method of claim 1, wherein the first requirements dataset also includes a second requirement, and the method further comprises:
identifying, at the requirement orchestrator module, a second intent based on the second requirement;
determining the first intent and the second intent are directed to the same goal; and
coupling the first requirement with the second requirement.

4. The method of claim 3, wherein selection of the first microservice is further based on the coupling of the first requirement with the second requirement.

5. The method of claim 1, wherein the first requirements dataset also includes a second requirement, and the method further comprises:
identifying, at the requirement orchestrator module, a second intent based on the second requirement;
selecting, at the architecture generator module, a second microservice from the set of microservices based on the second microservice accommodating a second goal associated with the second intent;
determining, by the architecture generator module, that a second dependency exists between the first application layer and the second microservice; and
identifying, by the architecture generator module, a second component as representing the most probable component for enabling the second dependency.

6. The method of claim 1, wherein the first intent is based on one of a reliability standard, a security standard, a cost optimization standard, an operational excellence standard, a performance efficiency standard, and a sustainability standard.

7. The method of claim 1, wherein the first application layer is one of a presentation layer, data layer, and a logic layer.

8. The method of claim 1, further comprising:
generating, at an architecture evaluator module, a digital twin model of the architecture diagram; and
simulating a first scenario to evaluate a performance of the digital twin model with respect to the first intent.

9. The method of claim 1, further comprising using the architecture diagram to facilitate provisioning of the cloud computing-based infrastructure.

10. A non-transitory computer-readable medium storing software comprising instructions executable by one or more computers which, upon such execution, cause the one or more computers to generate an application architecture for a cloud computing-based infrastructure by performing the following:
receive, at a requirement orchestrator module, a first requirements dataset for a software application including a first requirement;
identify, at the requirement orchestrator module using a first machine learning (ML) model trained to determine/identify an intent(s) for a given requirement, a first intent based on the first requirement;
pass, from the requirement orchestrator module, the first requirement and the first intent to an architecture generator module;
assign, at the architecture generator module, the first requirement to a first application layer based on the first intent;
select, at the architecture generator module, a first microservice from a set of microservices based on the first microservice providing a functionality associated with both the first requirement and the first intent;
determine, by the architecture generator module, that a first dependency exists between the first application layer and the first microservice;
identify, by the architecture generator module and with reference to a knowledge model of existing architectural solutions, a first component that enables the first dependency; and
generate, in response to identifying the first component that enables the first dependency, an architecture diagram that includes at least the first component and the first application layer.

11. The non-transitory computer-readable medium storing software of claim 10, wherein the instructions further cause the one or more computers to generate, using probabilistic modeling, a first dependency graph that encodes dependencies between two or more application layers of the software application, wherein determining that a first dependency exists between the first application layer and the first microservice is based in part on the first dependency graph.

12. The non-transitory computer-readable medium storing software of claim 10, wherein the first requirements dataset also includes a second requirement, and the instructions further cause the one or more computers to:
identify, at the requirement orchestrator module, a second intent based on the second requirement;
determine the first intent and the second intent are directed to the same goal; and
couple the first requirement with the second requirement.

13. The non-transitory computer-readable medium storing software of claim 12, wherein selection of the first microservice is further based on the coupling of the first requirement with the second requirement.

14. The non-transitory computer-readable medium storing software of claim 10, wherein the first requirements dataset also includes a second requirement, and the instructions further cause the one or more computers to:
identify, at the requirement orchestrator module, a second intent based on the second requirement;
select, at the architecture generator module, a second microservice from the set of microservices based on the second microservice accommodating a second goal associated with the second intent;
determine, by the architecture generator module, that a second dependency exists between the first application layer and the second microservice; and
identify, by the architecture generator module, a second component as representing the most probable component for enabling the second dependency.

15. The non-transitory computer-readable medium storing software of claim 10, wherein the first intent is based on one of a reliability standard, a security standard, a cost optimization standard, an operational excellence standard, a performance efficiency standard, and a sustainability standard.

16. A system for generating an application architecture for a cloud computing-based infrastructure comprising one or more computers and one or more storage devices storing instructions that are operable, when executed by the one or more computers, to cause the one or more computers to:
receive, at a requirement orchestrator module, a first requirements dataset for a software application including a first requirement;
identify, at the requirement orchestrator module using a first machine learning (ML) model trained to determine/identify an intent(s) for a given requirement, a first intent based on the first requirement;
pass, from the requirement orchestrator module, the first requirement and the first intent to an architecture generator module;
assign, at the architecture generator module, the first requirement to a first application layer based on the first intent;
select, at the architecture generator module, a first microservice from a set of microservices based on the first microservice providing a functionality associated with both the first requirement and the first intent;
determine, by the architecture generator module, that a first dependency exists between the first application layer and the first microservice;
identify, by the architecture generator module and with reference to a knowledge model of existing architectural solutions, a first component that enables the first dependency; and
generate, in response to identifying the first component that enables the first dependency, an architecture diagram that includes at least the first component and the first application layer.

17. The system of claim 16, wherein the instructions further cause the one or more computers to:
generate, at an architecture evaluator module, a digital twin model of the architecture diagram; and
simulating a first scenario to evaluate a performance of the digital twin model with respect to the first intent.

18. The system of claim 16, wherein the instructions further cause the one or more computers to automatically provision the cloud computing-based infrastructure based on the architecture diagram.

19. The system of claim 16, wherein the instructions further cause the one or more computers to assign, at the architecture generator module, the first requirement to a first application layer based on the first intent, the first application layer being one of a presentation layer, data layer, and a logic layer.

20. The system of claim 16, wherein the first requirements dataset also includes a second requirement, and the instructions further cause the one or more computers to:
identify, at the requirement orchestrator module, a second intent based on the second requirement;
select, at the architecture generator module, a second microservice from the set of microservices based on the second microservice accommodating a second goal associated with the second intent;
determine, by the architecture generator module, that a second dependency exists between the first application layer and the second microservice; and
identify, by the architecture generator module, a second component as representing the most probable component for enabling the second dependency.
